(19) United States
(12) Patent Application Publication
(10) Pub. No.: US 2009/0281465 A1
(43) Pub. Date: Nov. 12, 2009

(54) REHABILITATION AND TRAINING APPARATUS AND METHOD OF CONTROLLING THE SAME

(76) Inventors: Li-Chen Fu, Taipei City (TW); Wei-Wen Wang, Shuangsi Township (TW); Cheng-Chang Ho, Taipei City (TW); Yen-Yu Chou, Yonghe City (TW)

Correspondence Address: SCHMEISER, OLSEN & WATTS, 22 CENTURY HILL DRIVE, SUITE 302, LATHAM, NY, 12110, US

(21) Appl. No.: 12/166,656

(22) Filed: Jul. 2, 2008

(30) Foreign Application Priority Data
May 9, 2008 (TW) 97117291

(51) Int. Cl. A61H 1/00

(52) U.S. Cl. 601/5

(57) ABSTRACT

A rehabilitation and training apparatus is built based on the empirical law by introducing physical therapists' experiences into the apparatus to simulate the therapy with hands in the course of rehabilitation. The apparatus includes a multi-axis robotic arm, and a high-precision control system. The control system provides three operating modes, including an active, a passive, and an auxiliary mode; receives and computes information about a patient's movements and produced force detected by potentiometers and force sensors provided in the multi-axis robotic arm; and accordingly, drives actuators to apply an aiding force or a resisting force to assist the patient in completing and repeating rehabilitation exercises. The apparatus also includes a humanized operating interface, via which a doctor or a physical therapist may obtain related rehabilitation data for assessment and adjustment of rehabilitation therapeutic courses. A method of controlling the apparatus is also provided.

### FIELD OF THE INVENTION

The present invention relates to a physical therapy apparatus for passive exercising, and more particularly to an apparatus for assisting a patient in completing and repeating rehabilitation exercises to train the patient's ability to stretch or bend muscles and joints.

### BACKGROUND OF THE INVENTION

The limbs are the human body portions that most frequently contact with external environment, and are therefore most easily subject to injury. According to the rehabilitation medicine, limb injuries may be generally divided into three types, namely, musculoskeletal disorders, neurological disorders, and childhood disorders. For example, the Adhesive Capsulitis, also called frozen shoulder, is one type of the musculoskeletal disorders most frequently suffered by the aged and the mid-aged. The limb injuries caused by neurological disorders and childhood disorders are most frequently found among young people. And, rehabilitation after surgery for breast cancer is generally found among women. From the above analyses, it can be found that the limb injuries are distributed among all ages. Therefore, the rehabilitation therapy is particularly important when considering from this viewpoint. The main purpose of rehabilitation therapy is to enhance the therapeutic effect and effectively shorten the duration of hospitalization, and to achieve the largest possible extent of body function recovery, so that the patient may live independently without relying on others.

In the traditional rehabilitation therapy, therapy with hands is still a main approach of therapy. However, the therapy with hands is relied on the physical therapist's personal experiences, and there is no means for accurately controlling the magnitude of applied force and the turning extent of joint. Under this circumstance, the patient is possibly subject to a second time injury. Moreover, the whole therapeutic course is quite long to spiritually and physically exhaust both the physical therapist and the patient. And, there are various kinds of rehabilitation apparatuses designed for different rehabilitation exercises. However, while the patients frequently take additional time and efforts to learn how to operate the rehabilitation devices, they fail to achieve the expected rehabilitation effect through using these rehabilitation devices.

It is therefore tried by the inventor to develop a rehabilitation and training apparatus that adopts the empirical law by introducing the physical therapists' experiences into the apparatus to simulate the therapy with hands, so as to assist the patient in achieving the target of rehabilitation and integrate different rehabilitation devices into one computer-controllable apparatus. A method of controlling the apparatus is also provided.

### SUMMARY OF THE INVENTION

A primary object of the present invention is to provide a rehabilitation and training apparatus that is built by introducing physical therapists' experiences into the apparatus to simulate therapy with hands in the rehabilitation therapeutic courses, and integrates different types of rehabilitation devices into one unit to conveniently assist a patient in achieving the rehabilitation.

To achieve the above and other objects, the rehabilitation and training apparatus according to the present invention includes a multi-axis robotic arm having a plurality of potentiometers for detecting different positions of the multi-axis robotic arm, a plurality of force sensors for detecting a force applied to the multi-axis robotic arm, and a plurality of actuators for driving the multi-axis robotic arm to move a patient's limbs and rotate the patient's joints; a position adjustment mechanism being connected at one end to the multi-axis robotic arm for moving the multi-axis robotic arm to a desired operating position; a movable base being connected to the other end of the position adjustment mechanism for conveniently moving the whole rehabilitation and training apparatus to a desired location; and a control system being electrically connected to the potentiometers and the force sensors for receiving and computing information detected and sent by the potentiometers and force sensors, and driving the actuators based on the computed information to control the multi-axis robotic arm; and the control system being able to record and analyze the patient's rehabilitation data.

Another object of the present invention is to provide a method of controlling the above-described rehabilitation and training apparatus, so that the apparatus may best assist a patient in completing and repeating different rehabilitation exercises. The control method includes the following steps: selecting one of an active mode, a passive mode, and an auxiliary mode from the control system; selecting a magnitude of resisting force to be applied by the multi-axis robotic arm when the active mode is selected; the control system receiving information detected and sent by the potentiometers and determining a direction in which a patient moves a limb; and the control system driving the actuators to apply a reverse resisting force to train the patient's muscular strength.

The control method further includes the following steps when the passive mode is selected: selecting a desired rehabilitation exercise from the control system; the control system determining whether the multi-axis robotic arm is in an initial position corresponding to the selected rehabilitation exercise; and the multi-axis robotic arm starting performing and repeating the selected rehabilitation exercise when the multi-axis robotic arm has been returned to the initial position.

The control method further includes the following steps when the auxiliary mode is selected: selecting a desired rehabilitation exercise from the control system; the control system determining whether the multi-axis robotic arm is in an initial position corresponding to the selected rehabilitation exercise; the patient starting performing and repeating the selected rehabilitation exercise when the multi-axis robotic arm has been returned to the initial position; and the control system receiving information about a magnitude of force produced by the patient detected and sent by the force sensors and information about a direction of the force produced by the patient detected and sent by the potentiometers, and driving the actuators to apply an aiding force in the same direction as that of the force produced by the patient, so as to help the patient to complete and repeat the selected rehabilitation exercise.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a rehabilitation and training apparatus according to the present invention with a patient sit thereon;

FIG. 2 is a perspective view of the rehabilitation and training apparatus of the present invention;

FIG. 3 is a perspective view showing a multi-axis robotic arm, a position adjusting mechanism, and a movable base included in the present invention;

FIG. 4 is a block diagram of a control system of the present invention; and

FIGS. 5a and 5b are to combine to form a flowchart showing the steps included in a method of controlling the rehabilitation and training apparatus of the present invention.

### DETAILED DESCRIPTION OF THE PREFERRED EMBODIMENTS

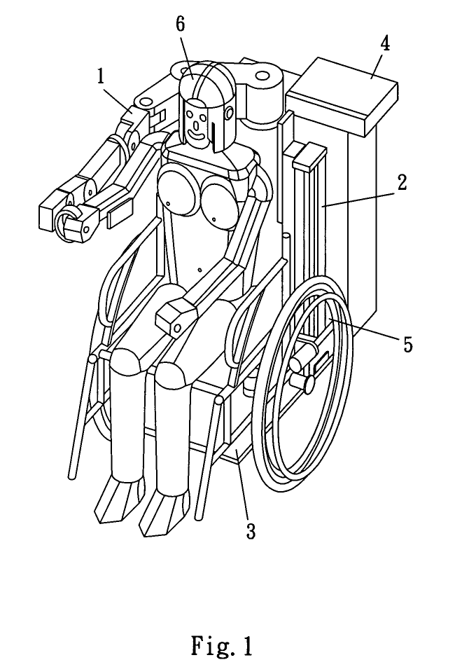

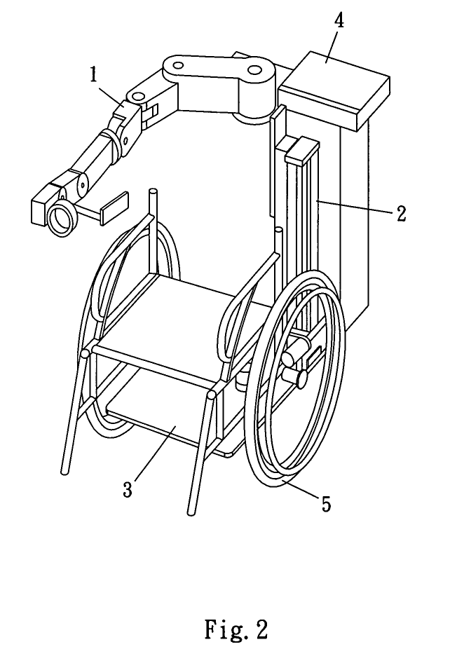

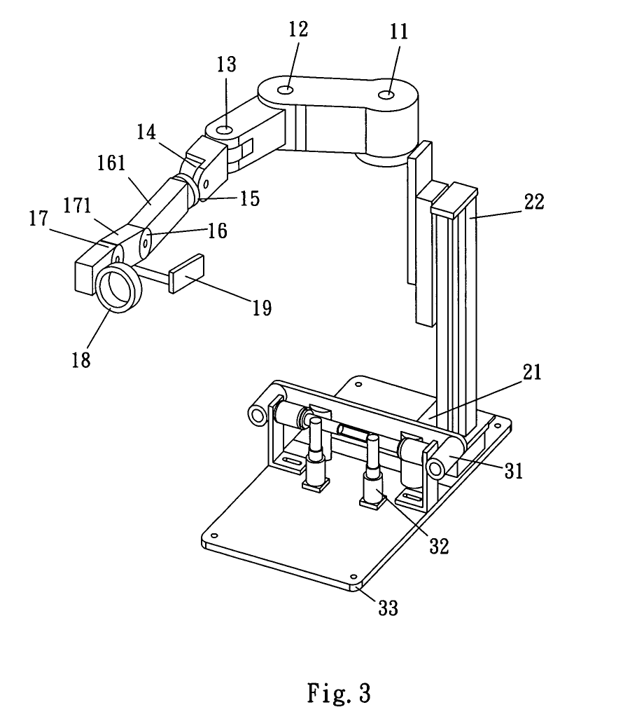

Please refer to FIGS. 1 and 2 that are two perspective views of a rehabilitation and training apparatus according to the present invention with and without a patient 6 sit thereon. As shown, the rehabilitation and training apparatus of the present invention includes a multi-axis robotic arm 1, a position adjustment mechanism 2, a movable base 3, and a control system 4. In a more preferred embodiment of the present invention, the rehabilitation and training apparatus may further include a wheelchair 5. FIG. 3 is a perspective view more clearly show how the multi-axis robotic arm 1, the position adjustment mechanism 2, and the movable base 3 are connected to one another.

The multi-axis robotic arm 1 provides eight degrees of freedom, and includes total eight arm segments, namely, a first arm segment 11, a second arm segment 12, a third arm segment 13, a fourth arm segment 14, a fifth arm segment 15, a sixth arm segment 16, a seventh arm segment 17, and an eighth arm segment 18. The first, the second, and the third arm segment 11, 12, 13 are capable of moving horizontally. To enable versatile rehabilitation exercises, including some highly difficult exercises, such as brushing or combing hair, these three arm segments 11, 12, 13 must be actively movable and adjustable at any time for the whole robotic arm 1 to always locate at a desired position. The fourth arm segment 14 is movable vertically mainly for assisting the patient 6 in raising shoulders or thighs. On the other hand, the third arm segment 13 is relied to help the patient 6 to stretch shoulders or thighs. The fifth arm segment 15 is able to rotate mainly for assisting the patient 6 in turning arm or knee joints. The sixth arm segment 16 is movable vertically mainly for assisting the patient 6 in raising forearms or shanks. The seventh arm segment 17 is movable vertically mainly for assisting the patient 6 in raising palms or foot thenar. The eighth arm segment 18 is rotatable mainly for helping the patient to turn wrist or ankle joints.

These eight arm segments are provided with a potentiometer 4112 each (not shown in FIGS. 1 to 3) for measuring the angles at the patient's different joints, a force sensor 4113 each (not shown in FIGS. 1 to 3) for detecting the force applied to each of the arm segments, and an actuator 4111 each (not shown in FIGS. 1 to 3) for driving the arm segments to assist the patient 6 in moving limbs and rotating joints. Further, to adapt for different patients who have different limb lengths, the rehabilitation and training apparatus of the present invention is provided at positions corresponding to a patient's upper arm/thigh and forearm/shank with an upper arm/thigh length adjustor 161 and a forearm/shank length adjustor 171, respectively. And, a support member 19 is provided at a predetermined position on the rehabilitation and training apparatus mainly for supporting and holding the patient's limb in place. The support member 19 may be a handle or a member capable of enclosing the patient's one limb.

The position adjustment mechanism 2 is connected at one end to the multi-axis robotic arm 1 for moving the latter to a desired operating position, and includes a horizontal linear sliding rail 21 and a vertical linear sliding rail 22. With the two-degree of freedom of the position adjustment mechanism 2, the multi-axis robotic arm 1 may be adjusted to any desired operating position to adapt to different heights of patients sitting on the wheelchair 5.

The movable base 3 is connected to the other end of the position adjustment mechanism 2, and includes a wheelchair fixing unit 31 for immovably holding a wheelchair 5 to the base 3, a platform fixing unit 32 for stably holding the base 3 in place without the risk of swinging, and a set of base casters 33. For a patient who is currently not convenient to walk and must rely on a wheelchair, the nurse needs only to push the wheelchair 5 with the patient 6 sitting thereon to engage with the wheelchair fixing unit 31, and the patient 6 may start doing a rehabilitation exercise directly on the wheelchair 5. The base casters 33 allow a nurse to easily push the whole rehabilitation and training apparatus to a ward for use when the patient could not move easily.

The control system 4 is upright located on the movable base 3 behind the position adjustment mechanism 2, and is electrically connected to the potentiometers 4112 and the force sensors 4113 for receiving and computing information detected and sent by the potentiometers 4112 and the force sensors 4113, and driving the actuators 4111 based on the computed results, so as to control the multi-axis robotic arm 1 to move. The control system 4 also records and analyzes data showing the patient's rehabilitation conditions.

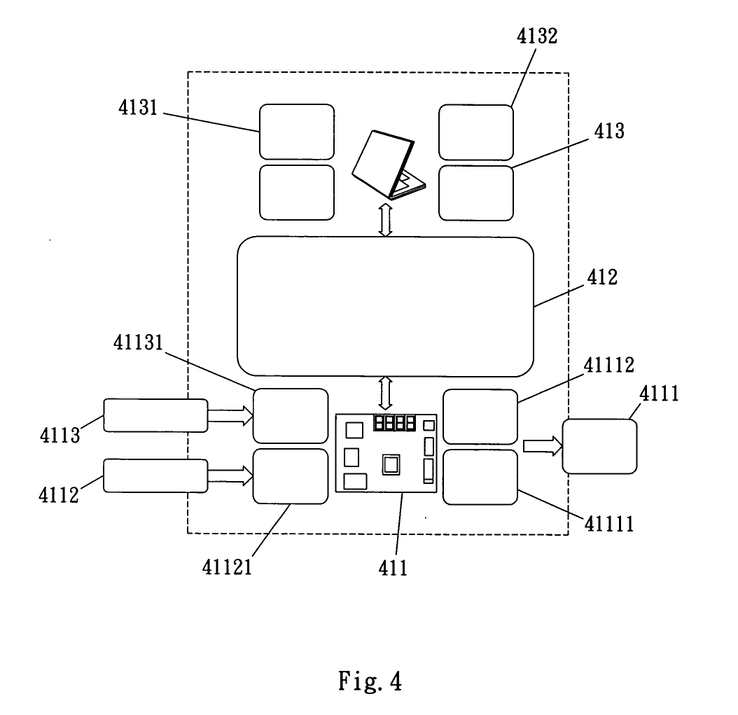

FIG. 4 is a block diagram of the control system 4. The control system 4 is divided into three parts each having a different function, namely, a sensing system 411, a main controller 412, and a humanized operating interface 413.

The sensing system 411 is configured to receive and process the sensed information and send the processed information to the main controller 412 for use as a basis of decision making. Then, the actuators 4111 are driven via an actuator driving module 41111, so that all the arm segments 11 to 18 are moved into their respective specified positions. Meanwhile, the main controller 412 keeps receiving the sensed information, such as position information sent back by an actuator encoder 41112, and converts analog signals indicating the angle information from the potentiometers 4112 into digital signals via a digital analog converting module 41121. The digital signals are then sent to the main controller 412 for analyzing and correcting errors in positions and angles.

During the rehabilitation therapeutic courses, the main controller 412 will utilize a databank 4132 to establish files for some data required by therapists and doctors, and show the data on a display interface 4131 for viewing and using by the doctors and therapists as basis in assessing the effects of rehabilitation.

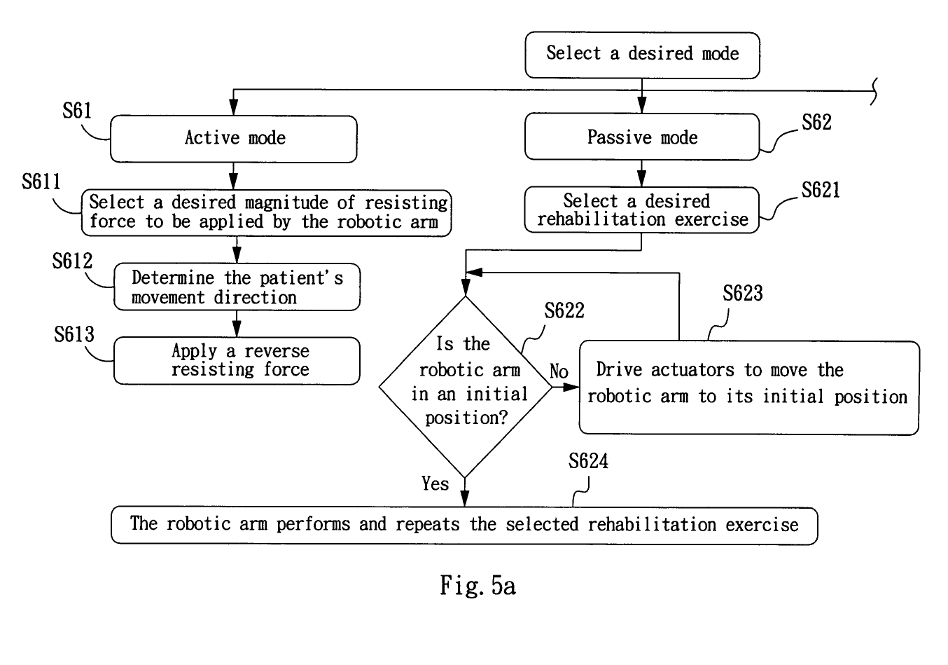

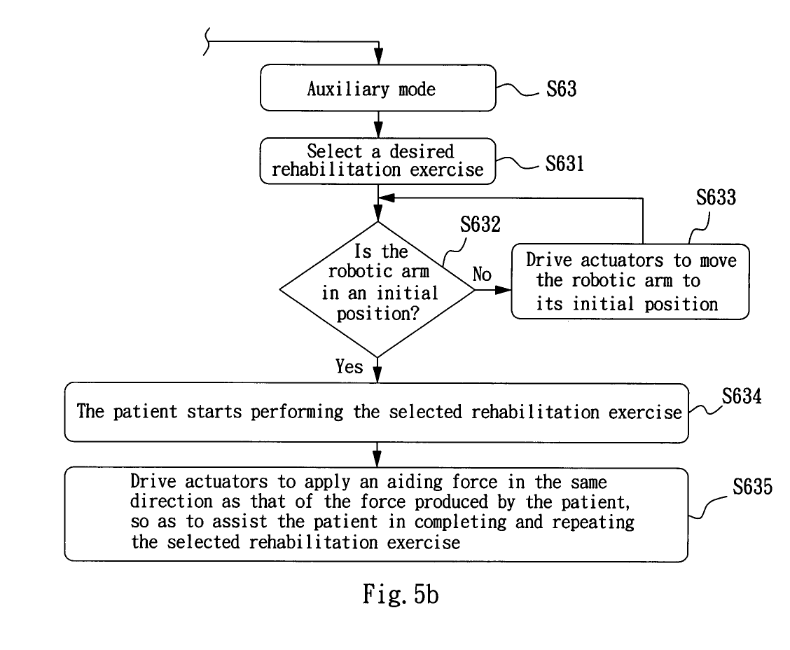

When the patient's physical condition is improved, the doctors and therapists may select via the humanized operating interface 413 one of three operating modes, namely, an active mode S61, a passive mode S62, and an auxiliary mode S63 (refer to FIG. 5b) for the patient. And, the force sensors 4113 are driven to measure the patient's muscular strength. The measured information is sent to the main controller 412 via a transmission protocol set by an RS232 module 41131, so that the main controller 412 drives the actuators 4111 via the actuator driving module 41111 to assist the patient 6 in completing the rehabilitation exercises by producing an adequate aiding force or resisting force to the patient.

FIGS. 5a and 5b are to combine to form a flowchart showing the steps included in a method of controlling the rehabilitation and training apparatus of the present invention. The above-mentioned active mode S61, passive mode S62, and auxiliary mode S63 will now be described in more details with reference to FIGS. 5a and 5b.

The active mode S61 allows the rehabilitation and training apparatus of the present invention to provide the training function, and is suitable for a patient whose arms meet the condition of producing force by themselves. In the active mode, the patient using the apparatus to do rehabilitation exercises may select according to his or her own physical conditions the magnitude of resisting force to be provided by the robotic arm (S611), just like someone in a gym to adjust the pounds of dumbbell by himself. Then, the main controller 412 receives via the digital analog converting module 41121 the information from the potentiometers 4112, and determines the direction of the patient's movement based on the received information (S612). Thereafter, the main controller 412 drives the actuators 4111 to apply a resisting force in a direction opposite to the patient's movement direction (S613). For example, when the patient produces an upward force, the main controller 412 would integrate the direction of the patient's movement and drive the actuators 4111 to apply a downward resisting force.

The passive mode S62 allows the rehabilitation and training apparatus of the present invention to provide the rehabilitation function suitable for a patient at an early stage of recovery. That is, the patient is currently unable to produce force by himself and requires full aid from the apparatus to achieve the rehabilitation effect. When the apparatus is in the passive mode, a desired rehabilitation exercise for the patient may be selected from the databank 4132 (S621). Information about the selected rehabilitation exercise is sent to the main controller 412 via the RS232 module 41131. Then, the main controller 412 would determine whether the multi-axis robotic arm 1 is in an initial position (S622). If the multi-axis robotic arm 1 is not in the initial position, the main controller 412 would drive the actuators 4111 to move the arm segments 11 to 18 of the multi-axis robotic arm 1 to their respective initial positions (S623). When the multi-axis robotic arm 1 has been returned to its initial position, it would start performing the selected rehabilitation exercise and repeat the same exercise (S624).

The auxiliary mode S63 allows the rehabilitation and training apparatus of the present invention to provide the rehabilitation function suitable for a patient who is able to produce force to some extent but has not fully recovered. When the apparatus is in the auxiliary mode, the patient may select a desired rehabilitation exercise from the databank 4132 (S631). Information about the selected rehabilitation exercise is sent to the main controller 412 via the RS232 module 41131. Then, the main controller 412 would determine whether the multi-axis robotic arm 1 is in an initial position (S632). If the multi-axis robotic arm 1 is not in the initial position, the main controller 412 would drive the actuators 4111 to move the arm segments 11 to 18 of the multi-axis robotic arm 1 to their respective initial positions (S633). When the multi-axis robotic arm 1 has been returned to its initial position, the patient may start performing the selected rehabilitation exercise (S634). The force sensors 4113 would detect the force produced by the patient and send the detected information to the control system 4, so that the control system 4 drives the actuators 4111 to apply an aiding force in the same direction as that of the force produced by the patient to assist the patient in completing and repeating the selected rehabilitation exercise (S635).

The present invention has been described with a preferred embodiment thereof and it is understood that many changes and modifications in the described embodiment can be carried out without departing from the scope and the spirit of the invention that is intended to be limited only by the appended claims.

What is claimed is:

1. A rehabilitation and training apparatus, comprising:
a multi-axis robotic arm provided with:
a plurality of potentiometers for detecting different positions of the multi-axis robotic arm;
a plurality of force sensors for detecting forces applied to the multi-axis robotic arm; and
a plurality of actuators for driving the multi-axis robotic arm to move a patient's limbs and rotate the patient's joints;
a position adjustment mechanism being connected at one end to the multi-axis robotic arm for moving the multi-axis robotic arm to a desired operating position;
a movable base being connected to the other end of the position adjustment mechanism to enable convenient moving of the whole rehabilitation and training apparatus to a desired location; and
a control system being electrically connected to the potentiometers and the force sensors for receiving and computing information detected and sent by the potentiometers and force sensors, and driving the actuators based on the computed information to control the multi-axis robotic arm; and the control system being able to record and analyze the patient's rehabilitation data.

2. The rehabilitation and training apparatus as claimed in claim 1, wherein the multi-axis robotic arm further includes at least one adjustor for adjusting an overall length of the multi-axis robotic arm.

3. The rehabilitation and training apparatus as claimed in claim 1, wherein the multi-axis robotic arm further includes at least one support member for supporting and moving the patient's one limb.

4. The rehabilitation and training apparatus as claimed in claim 2, wherein the multi-axis robotic arm further includes at least one support member for supporting and moving the patient's one limb.

5. The rehabilitation and training apparatus as claimed in claim 3, wherein the support member is selected from the group consisting of a handle for gripping and a member capable of enclosing the patient's limb.

6. The rehabilitation and training apparatus as claimed in claim 4, wherein the support member is selected from the group consisting of a handle for gripping and a member capable of enclosing the patient's limb.

7. The rehabilitation and training apparatus as claimed in claim 1, wherein the movable base further includes a wheelchair fixing unit for engaging with a wheelchair, allowing a patient to do rehabilitation exercises while sitting on the wheelchair.

8. The rehabilitation and training apparatus as claimed in claim 2, wherein the movable base further includes a wheelchair fixing unit for engaging with a wheelchair, allowing a patient to do rehabilitation exercises while sitting on the wheelchair.

9. The rehabilitation and training apparatus as claimed in claim 3, wherein the movable base further include a wheelchair fixing unit for engaging with a wheelchair, allowing a patient to do rehabilitation exercises while sitting on the wheelchair.

10. The rehabilitation and training apparatus as claimed in claim 4, wherein the movable base further include a wheelchair fixing unit for engaging with a wheelchair, allowing a patient to do rehabilitation exercises while sitting on the wheelchair.

11. The rehabilitation and training apparatus as claimed in claim 5, wherein the movable base further include a wheelchair fixing unit for engaging with a wheelchair, allowing a patient to do rehabilitation exercises while sitting on the wheelchair.

12. The rehabilitation and training apparatus as claimed in claim 6, wherein the movable base further include a wheelchair fixing unit for engaging with a wheelchair, allowing a patient to do rehabilitation exercises while sitting on the wheelchair.

13. A method of controlling a rehabilitation and training apparatus, comprising the following steps:
providing a rehabilitation and training apparatus having a multi-axis robotic arm, a position adjustment mechanism, a movable base, and a control system; and the multi-axis robotic being provided with a plurality of potentiometers, force sensors, and actuators electrically connected to the control system;
selecting one of an active mode, a passive mode, and an auxiliary mode from the control system;
selecting a magnitude of resisting force to be applied by the multi-axis robotic arm when the active mode is selected;
the control system receiving information detected and sent by the potentiometers and determining a direction in which a patient moves a limb; and
the control system driving the actuators to apply a reverse resisting force to train the patient's muscular strength.

14. The control method as claimed in claim 13, further comprising the following the steps when the passive mode is selected:
selecting a desired rehabilitation exercise from the control system;
the control system determining whether the multi-axis robotic arm is in an initial position corresponding to the selected rehabilitation exercise; and
the multi-axis robotic arm starting performing and repeating the selected rehabilitation exercise when the multi-axis robotic arm has been returned to the initial position.

15. The control method as claimed in claim 13, further comprising the following the steps when the auxiliary mode is selected:
selecting a desired rehabilitation exercise from the control system;
the control system determining whether the multi-axis robotic arm is in an initial position corresponding to the selected rehabilitation exercise;
the patient starting performing the selected rehabilitation exercise when the multi-axis robotic arm has been returned to the initial position; and
the control system receiving information about a magnitude of force produced by the patient detected and sent by the force sensors and information about a direction of the force produced by the patient detected and sent by the potentiometers, and driving the actuators to apply an aiding force in the same direction as that of the force produced by the patient, so as to help the patient to complete and repeat the selected rehabilitation exercise.

16. The control method as claimed in claim 14, further comprising the following the steps when the auxiliary mode is selected:
selecting a desired rehabilitation exercise from the control system;
the control system determining whether the multi-axis robotic arm is in an initial position corresponding to the selected rehabilitation exercise;
the patient starting performing the selected rehabilitation exercise when the multi-axis robotic arm has been returned to the initial position; and
the control system receiving information about a magnitude of force produced by the patient detected and sent by the force sensors and information about a direction of the force produced by the patient detected and sent by the potentiometers, and driving the actuators to apply an aiding force in the same direction as that of the force produced by the patient, so as to help the patient to complete and repeat the selected rehabilitation exercise.
